(19) United States
(12) Patent Application Publication
(10) Pub. No.: US 2006/0285175 A1
(43) Pub. Date: Dec. 21, 2006

(54) Scanner for penetrative documents

(76) Inventor: Kuo-Kuang Wu, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/156,195

(22) Filed: Jun. 17, 2005

(51) Int. Cl. H04N 1/04

(52) U.S. Cl. 358/474; 358/498

(57) ABSTRACT

The present invention provides a scanner for penetrative documents including a scanning housing, a feeding housing disposed on the scanning housing and a conveyor tray disposed between the scanning housing and the feeding housing. The scanning housing has a scanning window disposed thereon and a scanning base disposed therein. The scanning base has a scanning means and a lower light source. The feeding housing has a feeding mechanism and an upper light source disposed therein. The feeding mechanism is used to convey bendable documents. The upper light source is located over the scanning window. The conveyor tray moves horizontally between the scanning housing and the feeding housing for conveying bendable or non-bendable documents to pass through the scanning window. Therefore the function of scanning non-bendable documents of the feeder type scanner is realized.

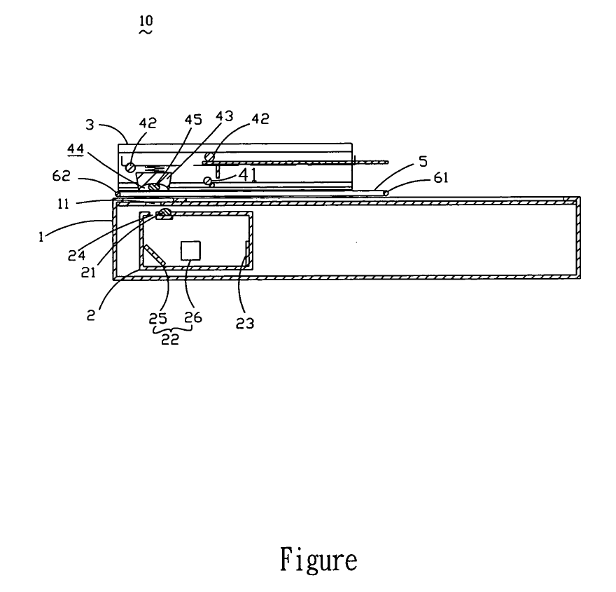

### BACKGROUND OF THE INVENTION

1. Field of the Invention

The present invention relates to a scanner, and more particularly to a scanner for penetrative documents.

2. The Related Art

Generally, traditional feeder type scanner only provides a function of scanning reflective documents, but cannot scan penetrative documents. In order to realize the function of scanning penetrative documents, U.S. Pat. No. 6,252,684, which provides a feeder type scanner, comprises a scanning housing, a scanning window disposed on the scanning housing, a scanning base disposed in the scanning housing, a feeding housing disposed on the scanning housing. The scanning base has a scanning means and a lower light source. The scanning means comprises a light transmission mechanism and an image sensor. The scanning housing has a feeding mechanism and an upper light source disposed therein. The feeding mechanism is used to convey bendable documents and comprises a group of drawing wheels, a group of feeding wheels and a wheel driven mechanism. Light from the upper light source is adapted for illuminating penetrative documents and penetrating through the penetrative documents to the light transmission mechanism, and then is transmitted to the image sensor. Therefore, the function of scanning penetrative documents of the feeder type scanner is realized.

However, the above scanner conveys documents by the wheels, so the scanner can only scan bendable documents. The non-bendable documents cannot still be scanned, which take a lot of inconvenience to the user of the feeder type scanner.

### SUMMARY OF THE INVENTION

An object of the present invention is to provide a scanner for penetrative documents including: a scanning housing having a scanning window defined thereon; a scanning means disposed inside the scanning housing which comprises a light transmission mechanism and an image sensor; a feeding housing disposed on the scanning housing; a feeding mechanism disposed inside the feeding housing for conveying bendable documents to pass through the scanning window; a conveyor tray disposed between the scanning housing and the feeding housing, the conveyor tray moving horizontally between the scanning housing and the feeding housing for conveying bendable or non-bendable documents to pass through the scanning window; a lower light source disposed below the scanning window, light from the lower light source being adapted for illuminating reflective documents and being reflected to the light transmission mechanism by the reflective documents, and then the reflected light being transmitted to the image sensor by the light transmission mechanism; and an upper light source disposed inside the feeding housing and located over the scanning window, light from the upper light source being adapted for illuminating penetrative documents and penetrating through the penetrative documents to the light transmission mechanism, and then being transmitted to the image sensor. Therefore, the function of scanning non-bendable documents of the feeder type scanner is realized.

### BRIEF DESCRIPTION OF THE DRAWINGS

The present invention will be apparent to those skilled in the art by reading the following description of a preferred embodiment thereof, with reference to the attached drawing, in which:

The FIGURE is a cross-sectional view of the scanner for penetrative documents according to the present invention.

### DETAILED DESCRIPTION OF THE PREFERRED EMBODIMENT

Referring to the FIGURE, a scanner for penetrative documents 10 according to the present invention comprises a scanning housing 1, a scanning window 11 defined on the scanning housing 1, a scanning base 2 disposed inside the scanning housing 1, a feeding housing 3 disposed on the scanning housing 1, a conveyor tray 5 disposed between the scanning housing 1 and the feeding housing 3.

The scanning base 2 has a scanning means disposed therein and a lower light source 21 disposed thereon. The scanning means scans documents passing through the scanning window 11. The scanning means comprises a light transmission mechanism 22 and an image sensor 23. The light transmission mechanism 22 has a reflector 24 and a plurality of lens 25. The scanning base 2 further has an opening 26 defined on the upper surface thereof. The opening 26 is opposite to the reflector 24 and is under the scanning window 11.

The feeding housing 3 rotatably couples to the scanning housing 1 and closes to the scanning housing 1 as far as possible in order to avoid light leaking. The lower surface of the feeding housing 3 is hollowed out at the position opposite to the scanning window 11 in order to allow the light to penetrate through the scanning window 11. The feeding housing 3 has a feeding mechanism and an upper light source 45 disposed therein.

The feeding mechanism conveys bendable documents to pass through the scanning window 11. The feeding mechanism comprises a group of drawing wheels 41, a group of feeding wheels 42, a press board 43 and a wheel driven mechanism (not shown). The press board 43 is placed over the scanning window 11 and hollowed up to form a room 44 at the middle of the bottom surface thereof. The upper light source 45, a small-area linear light source, such as tube, is mounted in the room 44.

The conveyor tray 5 driven by a tray driven mechanism can carry all kinds of documents, especially bendable documents such as a positive and a negative. In this embodiment, the conveyor tray 5 is a transparent conveyor belt. The tray driven mechanism comprises a first driving wheel 61, a second driving wheel 62 and a driving motor (not shown). The first driving wheel 61 is set over the front of the scanning housing 1. The second driving wheel 62 is set over the back of the scanning housing 1. The conveyor belt surrounds the first driving wheel 61 and the second driving wheel 62 and is stretched tight, so the upper surface of the conveyor belt forms a horizontal conveying surface.

When scanning bendable documents, the drawing wheels 41 and the feeding wheels 42 of the feeding mechanism convey bendable documents between the press board 43 and the scanning window 11. If the bendable documents are reflective documents, the lower light source 21 is switched on. Light from the lower light source 21 illuminates the reflective documents and is reflected through the opening 26 to the light transmission mechanism 22 by the reflective documents, and then the reflected light is transmitted to the image sensor 23 by the light transmission mechanism 22. If the bendable documents are penetrative documents, the upper light source 45 is switched on. Light from the upper light source 45 illuminates the penetrative documents and penetrates through the penetrative documents and the opening 26 to the light transmission mechanism 22, and then is transmitted to the image sensor 23.

When scanning non-bendable documents, put the non-bendable documents on the back of the horizontal conveyor surface of the conveyor belt, meanwhile the upper light source 45 is switched on if the non-bendable documents are penetrative documents, or the lower light source 21 is switched on if the non-bendable documents are reflective documents. The driving motor drives the first driving wheel 61 and the second driving wheel 62 turn around at a same speed, which drives the conveyor belt move ahead horizontally. Thus the conveyor belt carries the non-bendable documents to move ahead smoothly. When the non-bendable reflective documents arrive at the scanning window 11, Light from the lower light source 21 illuminates the non-bendable reflective documents and is reflected through the opening 26 to the light transmission mechanism 22 by the reflective documents, and then the reflected light is transmitted to the image sensor 23 by the light transmission mechanism 22. When the non-bendable penetrative documents arrive at the scanning window 11, light from the upper light source 45 illuminates the non-bendable penetrative documents and penetrates through the non-bendable penetrative documents and the opening 26 to the light transmission mechanism 22, and then is transmitted to the image sensor 23. When the documents completely pass through the scanning window 11, the scanning is finished. Besides, the conveyor tray 5 can also convey bendable documents, and the process of conveying bendable documents is the same as conveying non-bendable documents.

Although a preferred embodiment of the present invention has been described in detail hereinabove, it should be clearly understand that many variations and/or modifications of the basic inventive concepts herein taught which may appear to those skilled in the present art will fall within the spirit and scope of the present invention, as defined in the appended claims.

What is claimed is:

1. A scanner for penetrative documents, comprising:
a scanning housing having a scanning window defined thereon;
a scanning means disposed inside the scanning housing which comprises a light transmission mechanism and an image sensor;
a feeding housing disposed on the scanning housing;
a feeding mechanism disposed inside the feeding housing for conveying bendable documents to pass through the scanning window;
a conveyor tray disposed between the scanning housing and the feeding housing, the conveyor tray moving horizontally between the scanning housing and the feeding housing for conveying bendable or non-bendable documents to pass through the scanning window;
a lower light source disposed below the scanning window, light from the lower light source being adapted for illuminating reflective documents and being reflected to the light transmission mechanism by the reflective documents, and then the reflected light being transmitted to the image sensor by the light transmission mechanism; and
an upper light source disposed inside the feeding housing and located over the scanning window, light from the upper light source being adapted for illuminating penetrative documents and penetrating through the penetrative documents to the light transmission mechanism, and then being transmitted to the image sensor.

2. The scanner for penetrative document as claimed in claim 1, further comprising a tray driven mechanism, the tray driven mechanism comprising a first driving wheel, a second driving wheel and driving motor, the conveyor tray being a transparent conveyor belt, the transparent conveyor belt surrounding the first driving wheel and the second driving wheel and being stretched tight, the driving motor driving the first driving wheel and the second driving wheel move smoothly.

3. The scanner for penetrative document as claimed in claim 1, wherein the feeding mechanism has a press board disposed therein, and the press board is placed over the scanning window of the scanning housing, the press board is hollowed up to form a room at the middle of the bottom surface, the upper light source is disposed inside the room.
